(19) United States
(12) Patent Application Publication
(10) Pub. No.: US 2024/0064593 A1
(43) Pub. Date: Feb. 22, 2024

(54) METHOD AND APPARATUS FOR CONDITIONAL PATH SWITCH IN A WIRELESS COMMUNICATION SYSTEM

(71) Applicant: Lenovo (Beijing) Limited, Beijing (CN)

(72) Inventors: Lianhai Wu, Beijing (CN); Bingchao Liu, Beijing (CN); Jing Han, Beijing (CN); Hongmei Liu, Beijing (CN); Haiming Wang, Beijing (CN)

(73) Assignee: Lenovo (Beijing) Limited, Beijing (CN)

(21) Appl. No.: 18/270,391

(22) PCT Filed: Dec. 30, 2020
(86) PCT No.: PCT/CN2020/141416

§ 371 Date: Jun. 29, 2023

(51) Int. Cl. H04W 36/00; H04W 36/36; H04W 36/30

(52) U.S. Cl. CPC H04W 36/033; H04W 36/362; H04W 36/304; H04W 36/0072; H04W 36/00835; H04W 88/04

(57) ABSTRACT

Embodiments of the present disclosure relate to methods and apparatuses for a conditional path switch in a wireless communication system. According to some embodiments of the disclosure, a method may include: receiving, at a user equipment (UE) from a serving cell, a radio resource control (RRC) reconfiguration message including at least one conditional path switch configuration associated with at least one execution condition; evaluating the at least one execution condition; and initiating a path switch procedure with a target node in response to an execution condition being met. Furthermore, the consecutive path switch may be configured.

### TECHNICAL FIELD

Embodiments of the present disclosure generally relate to wireless communication technology, especially to a conditional path switch in a wireless communication system.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a SL, rather than being linked through the BS. A relaying function based on a sidelink may be supported in a communication network. For example, a UE supporting sidelink communication may function as a relay node to extend the coverage of a BS. An out-of-coverage UE may communicate with a BS via a relay UE. In the context of the present disclosure, a UE, which functions as a relay between another UE and a BS, may be referred to a UE-to-network relay or a U2N relay.

There is a need for efficiently performing communication in a communication system supporting a U2N relay.

### SUMMARY

Some embodiments of the present disclosure provide a method. According to some embodiments of the present disclosure, the method may include: receiving, at a user equipment (UE) from a serving cell, a radio resource control (RRC) reconfiguration message including at least one conditional path switch configuration associated with at least one execution condition; evaluating the at least one execution condition; and initiating a path switch procedure with a target node in response to an execution condition being met.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions for a conditional path switch, and can facilitate and improve the implementation of various communication technologies such as 5G NR. For example, embodiments of the present disclosure provide technical solutions for a conditional path switch of a UE from a source Uu link to a relay link, from a relay link to a target Uu link, or from a source relay link to a target relay link.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure;

FIG. 2 illustrates a schematic diagram of a wireless communication system in accordance with some embodiments of the present disclosure;

FIG. 3 illustrates a schematic diagram of a wireless communication system in accordance with some embodiments of the present disclosure;

FIG. 4 illustrates a schematic diagram of a wireless communication system in accordance with some embodiments of the present disclosure;

FIG. 5 illustrates an exemplary path switch procedure in accordance with some embodiments of the present disclosure;

FIG. 6 illustrates an exemplary path switch procedure in accordance with some embodiments of the present disclosure;

FIG. 7 illustrates an exemplary path switch procedure in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

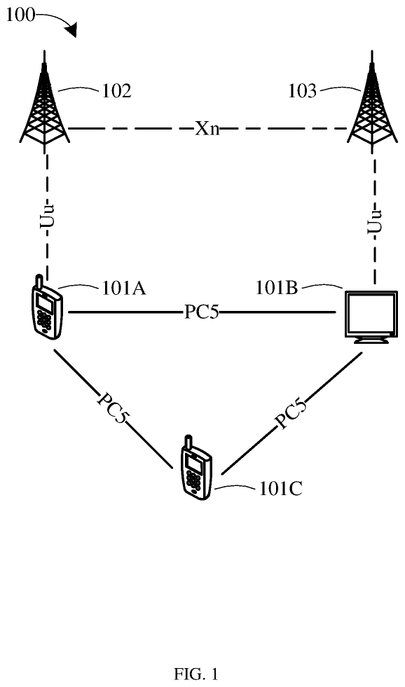

FIG. 1 illustrates a schematic diagram of a wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X Sidelink communication.

NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, the wireless communication system 100 may include some base stations (e.g., BS 102 and BS 103) and some UEs (e.g., UE 101A, UE 101B, and UE 101C). Although a specific number of UEs and BSs is depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, the BS 102 and the BS 103 may be included in a next generation radio access network (NG-RAN). In some embodiments of the present disclosure, the BS 102 may be a gNB and the BS 103 may be an ng-eNB.

The UE 101A and UE 101B may be in-coverage (e.g., inside the NG-RAN). For example, as shown in FIG. 1, the UE 101A may be within the coverage of BS 102, and the UE 101B may be within the coverage of BS 103. The UE 101C may be out-of-coverage (e.g., outside the coverage of the NG-RAN). For example, as shown in FIG. 1, the UE 101C may be outside the coverage of any BSs, for example, both the BS 102 and BS 103. The UE 101A and UE 101B may respectively connect to the BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. In some embodiments of the present disclosure, a UE-to-network relay is supported. For example, an in-coverage UE in communication with an out-of-coverage UE may function as a relay UE between the serving BS of the in-coverage UE and the out-of-coverage UE. In some embodiments of the present disclosure, a UE-to-UE relay is supported. For example, a UE in communication with two or more UEs (e.g., first and third UEs) may function as a relay UE, such that the first UE may communicate with the third UE via the relay UE.

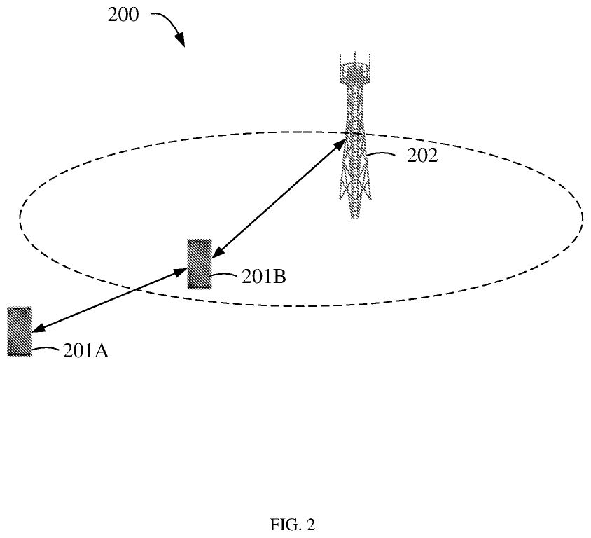

FIG. 2 illustrates a schematic diagram of a wireless communication system 200 in accordance with some embodiments of the present disclosure.

As shown in FIG. 2, the wireless communication system 200 may include a BS (e.g., BS 202) and some UEs (e.g., UE 201A and UE 201B). Although a specific number of UEs and BS is depicted in FIG. 2, it is contemplated that any number of UEs may be included in the wireless communication system 200.

Referring to FIG. 2, UE 201B may be within the coverage of BS 202. UE 201B and BS 202 may establish an RRC connection therebetween. UE 201A may be outside of the coverage of BS 202. In some examples, UE 201B may function as UE 101A or UE 101B shown in FIG. 1, and UE 201A may function as UE 101C shown in FIG. 1.

The wireless communication system 200 may support sidelink communications. For example, UE 201B may be in sidelink communication with UE 201A. A PC5 RRC connection may be established between UE 201A and UE 201B. In some embodiments of the present disclosure, UE 201A may initiate a procedure for establishing connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. UE 201A and BS 202 may establish an RRC connection therebetween, and UE 201A may have RRC states, such as an RRC_IDLE state, an RRC_INACTIVE state, and an RRC_CONNECTED state. UE 201A may also be referred to as a remote UE and UE 201B may also be referred to as a relay UE or a serving relay of UE 201A.

It should be appreciated by persons skilled in the art that although a single relay node between UE 201A and BS 202 is depicted in FIG. 2, it is contemplated that any number of relay nodes may be included.

Under certain circumstances, for example, when UE 201A moves from out-of-coverage to in-coverage, BS 202 (or the serving cell of UE 201A) may determine to switch UE 201A from the relay link to the Uu link. In some embodiments of the present disclosure, BS 202 (or the serving cell of UE 201A) may configure a conditional path switch for UE 201A, such that UE 201A can evaluate when to perform a path switch procedure from the relay link to the Uu link. Details regarding such conditional path switch procedure will be described in the following text.

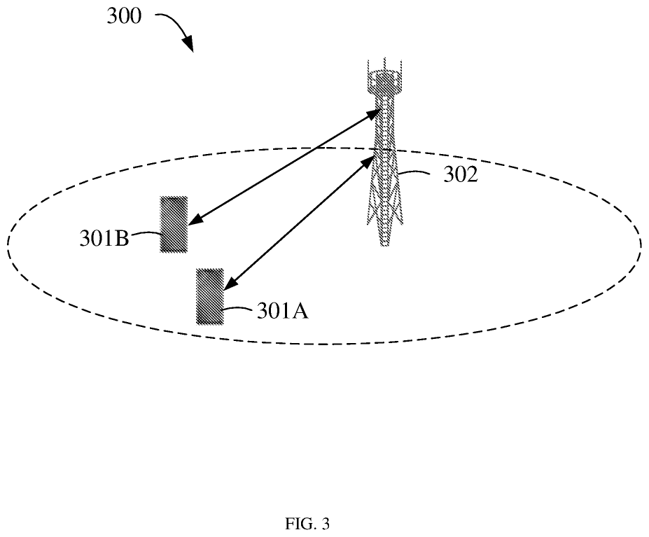

FIG. 3 illustrates a schematic diagram of a wireless communication system 300 in accordance with some embodiments of the present disclosure.

As shown in FIG. 3, the wireless communication system 300 may include a BS (e.g., BS 302) and some UEs (e.g., UE 301A and UE 301B). Although a specific number of UEs and BS is depicted in FIG. 3, it is contemplated that any number of UEs may be included in the wireless communication system 300.

Referring to FIG. 3, UE 301A and UE 301B may be within the coverage of BS 302. Each of UE 301A and UE 301B may establish a respective RRC connection with BS 302. In some examples, UE 301A and UE 301B may function as UE 101A or UE 101B shown in FIG. 1, or UE 201B shown in FIG. 2.

Under certain circumstances, for example, when UE 301A moves to the edge of the coverage area of BS 302, BS 302 (or the serving cell of UE 301A) may determine to switch UE 301A from the source Uu link to a relay link. For example, BS 302 may instruct 301A to establish a connection with UE 301B. UE 301A may then access BS 302 via UE 301B (for example, similar to FIG. 2 where UE 201A may access BS 202 via UE 201B). In some embodiments of the present disclosure, BS 202 (or the serving cell of UE 301A) may configure a conditional path switch for UE 301A, such that UE 301A can evaluate when to perform a path switch procedure from the Uu link to the relay link. Details regarding such conditional path switch procedure will be described in the following text.

In the context of the present disclosure, a conditional handover (CHO) can be considered a special case of a conditional path switch. The target node of a CHO is a cell.

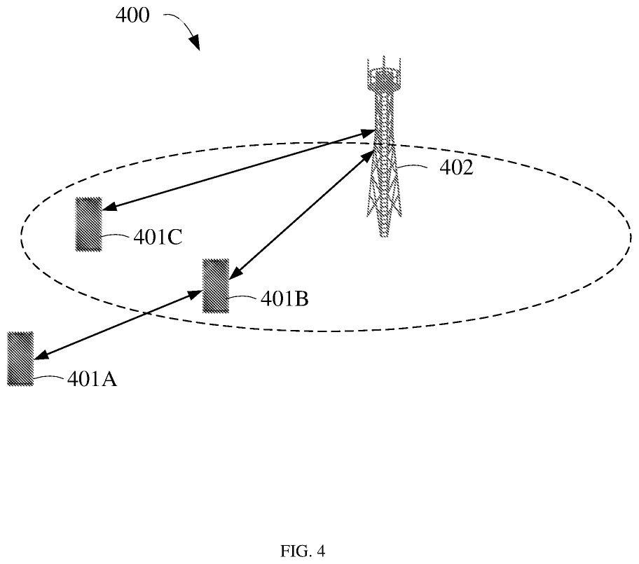

FIG. 4 illustrates a schematic diagram of a wireless communication system 400 in accordance with some embodiments of the present disclosure.

As shown in FIG. 4, the wireless communication system 400 may include a BS (e.g., BS 402) and some UEs (e.g., UE 401A, UE 401B, and UE 401C). Although a specific number of UEs and BS is depicted in FIG. 4, it is contemplated that any number of UEs may be included in the wireless communication system 400.

Referring to FIG. 4, UE 401B and UE 401C may be within the coverage of BS 402. UE 401B and UE 401C may establish respective RRC connections with BS 402. UE 401A may be outside of the coverage of BS 402. In some examples, UE 401B and 401C may function as UE 101A or UE 101B shown in FIG. 1, or UE 201B shown in FIG. 2, or UE 301A or UE 301B in FIG. 3; and UE 401A may function as UE 101C shown in FIG. 1 or UE 201A shown in FIG. 2.

The wireless communication system 400 may support sidelink communications. For example, UE 401B may be in sidelink communication with UE 401A. A PC5 RRC connection may be established between UE 401A and UE 401B. UE 401A may access BS 402 (or a cell of BS 402) via UE 401B. UE 401A may also be referred to as a remote UE and UE 401B may also be referred to as a relay UE.

It should be appreciated by persons skilled in the art that although a single relay node between UE 401A and BS 402 is depicted in FIG. 4, it is contemplated that any number of relay nodes may be included.

Under certain circumstances, for example, when UE 401A moves away from UE 401B, but is still outside the coverage of BS 402, BS 402 (or the serving cell of UE 401A) may determine to switch UE 401A from the source relay link (i.e., between UE 401A and UE 401B) to a target relay link (e.g., between UE 401A and UE 401C).

In some embodiments of the present disclosure, BS 402 (or the serving cell of UE 401A) may configure a conditional path switch for UE 401A, such that UE 401A can evaluate when to perform a path switch procedure from the source relay link to a target Uu link. Details regarding such conditional path switch procedure will be described in the following text.

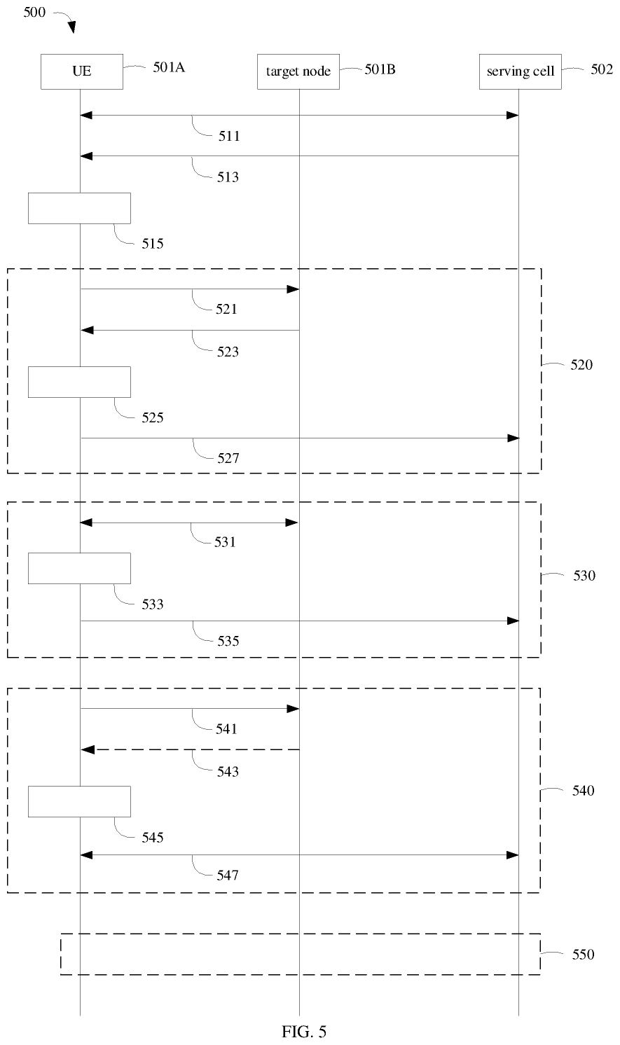

FIG. 5 illustrates an exemplary path switch procedure 500 in accordance with some embodiments of the present disclosure. Details described in all of the foregoing embodiments of the present disclosure are applicable for the embodiments shown in FIG. 5.

Referring to FIG. 5, UE 501A is accessing a cell (e.g., serving cell 502) of a BS (also referred to as “serving BS”). In some embodiments, UE 501A may access serving cell 502 via a relay UE. For example, UE 501A may function as UE 201A shown in FIG. 2 or UE 401A shown in FIG. 4. In some embodiments, UE 501A may access serving cell 502 using a Uu interface. For example, UE 501A may function as UE 301A or 301B shown in FIG. 3.

UE 501A may be configured with a measurement configuration by serving cell 502. In operation 511, UE 501A may report corresponding measurement results to serving cell 502.

In some embodiments of the present disclosure, UE 501A may report at least one candidate relay UE based on the measurement configuration. In some examples, UE 501A may report the candidate relay UE(s) after UE 501A measures and/or discovers the candidate relay UE(s). In some examples, the report may indicate at least one of: an identity (ID) of the at least one candidate relay UE, sidelink channel quality (e.g., reference signal received power (RSRP)) information between UE 501A and the at least one candidate relay UE. For example, UE 501A may report the ID of a candidate relay UE #A, and/or the sidelink channel quality information between UE 501A and the candidate relay UE #A.

In some examples, the candidate relay UE ID may be a layer-2 ID, a cell radio network temporary identifier (C-RNTI), or a UE ID indicated in a discovery message. For instance, during a UE discovery procedure, UE 501A may receive a discovery message from another UE, which may include an ID of the another UE. UE 501A may report such UE ID in the discovery message to serving cell 502.

In operation 513, serving cell 502 may transmit an RRC reconfiguration message to UE 501A. The RRC reconfiguration message may include at least one conditional path switch configuration associated with at least one execution condition. The at least one conditional path switch configuration may indicate one of the following: at least one execution condition for at least one candidate relay; at least one execution condition for at least one candidate cell; and at least one execution condition for at least one candidate relay and at least one execution condition for at least one candidate cell.

The conditional path switch configuration associated with a candidate cell and the execution condition for a candidate cell may also be referred to as “CHO configuration” and “CHO execution condition,” respectively. The CHO execution condition may be an A3 event or an A5 event as specified in 3GPP specification TS 38.331.

In some embodiments of the present disclosure, for each candidate relay, a respective conditional path switch configuration and at least one executive condition may be configured. The conditional path switch configuration associated with a candidate relay may include parameters for performing a path switch to the candidate relay. In response to an executive condition for a candidate relay being met, a path switch procedure with the candidate relay may be initiated. In some embodiments of the present disclosure, an execution condition is considered as being met when the execution condition is satisfied during a timer to trigger (TTT) period.

In some embodiments of the present disclosure, a single conditional path switch configuration may be configured for one or more candidate relays. In other words, one or more candidate relays may share the same conditional path switch configuration. For example, when a group of candidate relays are served by the same cell (e.g., serving cell 502 or another cell), a common conditional path switch configuration may be configured for the group of candidate relays.

In some embodiments of the present disclosure, a single execution condition may be configured for one or more candidate relays. In other words, one or more candidate relays may share the same execution condition. For example, when a group of candidate relays are served by the same cell (e.g., serving cell 502 or another cell), a common execution condition may be configured for the group of candidate relays.

In some embodiments of the present disclosure, the execution condition may be applied to the path switch of a UE (e.g., UE 501A) from a Uu link to a relay link. In some examples, the execution condition may be a condition event (hereinafter, “event #A1”) that the channel quality between the UE and a candidate relay becomes an offset better than the channel quality of the Uu link between the UE and the serving cell (e.g., primary cell (PCell)) of the UE. In other words, the channel quality between the UE and a candidate relay is better than the channel quality between the UE and its serving cell and the difference between the channel quality between the UE and the candidate relay and the channel quality between the UE and the serving cell is greater than the offset.

In some examples, the execution condition may be a condition event (hereinafter, “event #A2”) that the channel quality of the Uu link between the UE and the serving cell (e.g., primary cell (PCell)) of the UE becomes worse than a threshold (threshold #A1) and the channel quality between the UE and a candidate relay becomes better than another threshold (threshold #A2). In other words, the channel quality of the Uu link between the UE and its serving cell is less than threshold #A1, and the channel quality between the UE and the candidate relay is greater than threshold #A2.

In some examples, the execution condition may be a combination of event #A1 and event #A2. In other words, the difference between the channel quality between the UE and the candidate relay and the channel quality of the Uu link between the UE and its serving cell is greater than an offset, the channel quality of the Uu link between the UE and its serving cell is less than threshold #A1, and the channel quality between the UE and the candidate relay is greater than threshold #A2.

In some embodiments of the present disclosure, the execution condition may be applied to the path switch of a UE (e.g., UE 501A) from a relay link to a Uu link. In some examples, the execution condition may be a condition event (hereinafter, “event #B1”) that the channel quality between the UE and a candidate cell becomes an offset better than the channel quality of the PC5 link between the UE and the serving relay of the UE. In other words, the channel quality between the UE and a candidate cell is better than the channel quality between the UE and its serving relay and the difference between the channel quality between the UE and the candidate cell and the channel quality between the UE and the serving relay is greater than the offset.

In some examples, the execution condition may be a condition event (hereinafter, “event #B2”) that the channel quality of the PC5 link between the UE and the serving relay of the UE becomes worse than a threshold (threshold #B1) and the channel quality between the UE and a candidate cell becomes better than another threshold (threshold #B2). In other words, the channel quality between the UE and its serving relay is less than threshold #B1, and the channel quality between the UE and the candidate cell is greater than threshold #B2.

In some examples, the execution condition may be a combination of event #B1 and event #B2. In other words, the difference between the channel quality between the UE and the candidate cell and the channel quality between the UE and its serving relay is greater than an offset, the channel quality between the UE and its serving relay is less than threshold #B1, and the channel quality between the UE and the candidate cell is greater than threshold #B2.

In some embodiments of the present disclosure, the execution condition may be applied to the path switch of a UE (e.g., UE 501A) from a relay link to another relay link. In some examples, the execution condition may be a condition event (hereinafter, “event #C1”) that the channel quality between the UE and a candidate relay becomes an offset better than the channel quality of the PC5 link between the UE and the serving relay of the UE. In other words, the channel quality between the UE and a candidate relay is better than the channel quality between the UE and its serving relay and the difference between the channel quality between the UE and the candidate relay and the channel quality between the UE and the serving relay is greater than the offset.

In some examples, the execution condition may be a condition event (hereinafter, “event #C2”) that the channel quality of the PC5 link between the UE and the serving relay of the UE becomes worse than a threshold (threshold #C1) and the channel quality between the UE and a candidate relay becomes better than another threshold (threshold #C2). In other words, the channel quality between the UE and its serving relay is less than threshold #C1, and the channel quality between the UE and the candidate relay is greater than threshold #C2.

In some examples, the execution condition may be a combination of event #C1 and event #C2. In other words, the difference between the channel quality between the UE and the candidate relay and the channel quality between the UE and its serving relay is greater than an offset, the channel quality between the UE and its serving relay is less than threshold #C1, and the channel quality between the UE and the candidate relay is greater than threshold #C2.

The channel quality (e.g., reference signal received power (RSRP)) of a Uu link between a UE and a cell (either a serving cell or a candidate cell) may be measured based on the synchronization block (SSB) or channel-state information reference signal (CSI-RS). When a PC5 RRC connection (or a PC5 link) has not been established between a UE and a relay (e.g., a candidate relay), the channel quality (e.g., reference signal received power (RSRP)) between the UE and the relay may be measured based on a discovery message. When a PC5 RRC connection (or a PC5 link) has been established between a UE and a relay (either a serving relay or a candidate relay), the channel quality (e.g., RSRP) between the UE and the relay may be measured based on a reference signal (RS) such as a demodulation reference signal (DM-RS), or a channel-state information reference signal (CSI-RS).

A physical sidelink control channel (PSCCH) transmission may be associated with a DM-RS. A physical sidelink shared channel (PSSCH) may be associated with a DM-RS and may also be associated with a phase-tracking reference signal (PT-RS). A physical sidelink broadcast channel (PSBCH) may occupy 9 symbols and 5 symbols for normal and extended cyclic prefix cases respectively, including the associated DM-RS. Sidelink synchronization signals may include a sidelink primary synchronization signal (S-PSS) and a sidelink secondary synchronization signal (S-SSS), each of which may occupy 2 symbols and 127 subcarriers. For a measurement on the sidelink (e.g., between a UE and a relay UE), the following UE measurement quantities may be supported: PSBCH-RSRP, PSSCH-RSRP, and PSCCH-RSRP.

In this scenario, it would be problematic when different measurements are employed for a Uu link and a relay link, for example, the channel quality of a Uu link may be measured based on SSB or CSI-RS and the channel quality of a relay link may be measured based on a discovery message or a DM-RS with a PC5 RRC connection.

In some embodiments of the present disclosure, at least one offset may be configured to a UE to compensate the differences. For example, the RRC reconfiguration message may indicate the least one offset.

The least one offset may include an offset (offset #1) for the channel quality based on a discovery message when comparing the channel quality based on the discovery message with the channel quality based on an RS with a PC5 RRC connection. For example, offset #1 may be added to the channel quality based on a discovery message between a UE and a candidate relay, and then the added channel quality is compared with the channel quality of a PC5 link associated with the UE. A PC5 link associated with a UE means that a PC5 RRC connection has been established or to be established between the UE and another UE (either a serving relay or a candidate relay).

The least one offset may include an offset (offset #2) for the channel quality based on a discovery message when comparing the channel quality based on the discovery message with the channel quality of a Uu link. For example, offset #2 may be added to the channel quality based on a discovery message between a UE and a candidate relay and then the added channel quality is compared with the channel quality of a Uu link associated with the UE. A Uu link associated with a UE refers to a Uu link has been established or to be established between the UE and a cell (either a serving cell or a candidate cell).

The least one offset may include an offset (offset #3) for the channel quality based on an RS with a PC5 RRC connection when comparing the channel quality based on the RS with the PC5 RRC connection with the channel quality of a Uu link. For example, offset #3 may be added to the channel quality of a PC5 link associated with a UE, and then the added channel quality is compared with the channel quality of a Uu link associated with the UE.

In some embodiments of the present disclosure, the channel quality of a PC5 link associated with a UE may be limited to measurements on the S-PSS, S-SSS, or PSBCH.

Still referring to FIG. 5, in operation 515, UE 501A may evaluate the at least one execution condition configured by the RRC reconfiguration message. In some examples, an execution condition for a candidate node (either a candidate cell or a candidate relay) may be met. UE 501A may select this candidate node as a target node (e.g., target node 501B) and may initiate a path switch procedure with the target node. In the case that the target node is a cell, the path switch procedure may be a conditional handover procedure.

In some examples, the execution conditions for a plurality of candidate cells may be met. UE 501A may select one of the plurality of candidate cells as the target node based on, for example, the beam information, and may initiate a conditional handover procedure with the target node.

In some examples, the execution condition(s) for a plurality of candidate relays may be met. UE 501A may select one of the plurality of candidate relays as the target node according to, for example, the best channel quality among the channel qualities between the plurality of candidate relays and UE 501A.

In some examples, the execution condition(s) for one or more candidate relays and the execution condition(s) for one or more candidate cells may be met. UE 501A may select the target node based on certain criteria. The criteria for selecting the target node may include, but not limited to, the following: (1) selecting a candidate cell in priority; (2) selecting a candidate relay in priority; and (3) selecting the target node from the one or more candidate relays and the one or more candidate cells according to a best channel quality among the channel quality information between the one or more candidate relays and the UE and the channel quality information between the one or more candidate cells and the UE.

Based on criterion (1), UE 501A may first select the one or more candidate cells from the one or more candidate relays and the one or more candidate cells, and then select one of the one or more candidate cells based on, for example, the beam information.

Based on criterion (2), UE 501A may first select the one or more candidate relays from the one or more candidate relays and the one or more candidate cells, and then select one of the one or more candidate relays based on, for example, the channel quality information.

In some embodiments of the present disclosure, when selecting the best channel quality according to criterion (3), an offset may be configured for the comparison between the channel quality between a candidate relay and a UE and the channel quality between a candidate cell and the UE. The offset may be configured via the RRC reconfiguration message or predefined, for example, in a standard. For example, UE 501A may add the offset to the channel quality between one of the one or more candidate relays and UE 501A, and may compare the added channel quality with the channel quality between one of the one or more candidate cells and UE 501A.

In some embodiments of the present disclosure, the latency requirement may be considered during the evaluation of the execution condition and/or the selection of the target node.

In some examples, when a latency requirement of an ongoing service at a UE (e.g., UE 501A) is less than or equal to a threshold (e.g., 5 ms), the UE may not evaluate the configured execution condition(s) for the candidate relay(s).

In some examples, when a latency requirement of an ongoing service at a UE (e.g., UE 501A) is less than or equal to a threshold, the UE may not select any candidate relay even when the execution condition for the candidate relay is met.

In some examples, the latency requirement may be used as an execution condition. For example, the at least one execution condition for the at least one candidate relay may include an execution condition that a latency between a UE and a candidate relay is less than or equal to a threshold. The latency between the UE and a candidate relay may be determined based on a weighting factor (hereinafter, “W”). For example, the latency between the UE and a candidate relay can be determined according to the following formula:

W×quality+(1−W) (1)

In above formula (1), “quality” denotes the channel quality between the UE and the candidate relay. The threshold and the value of W may be determined based on the latency requirement of an ongoing service at the UE, may be configured by the BS, or may be predefined, for example, in a standard.

In some examples, when the execution conditions for a plurality of candidate nodes (either candidate relay or candidate cell) are met, latencies between the plurality of candidate nodes and the UE may be considered during the selection of the target node. For instance, the UE may a candidate link with relatively low (e.g., the lowest) latency. For instance, in the case that the execution condition for one or more candidate relays and the execution condition for one or more candidate cells being met, a UE may select the one or more candidate cells in priority when a latency requirement of an ongoing service at the UE is less than or equal to a threshold.

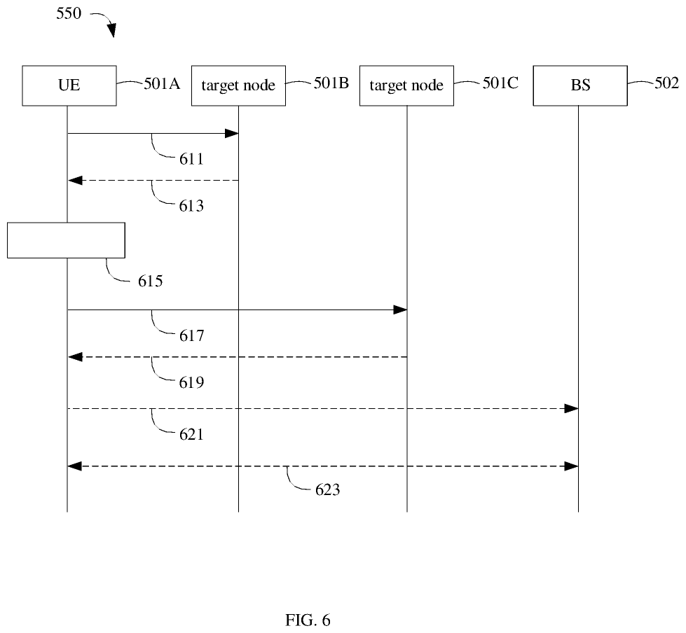

After selecting the target node (e.g., target node 501B), UE 501A may perform a path switch procedure with the target node. UE 501A may or may not detach the source link in response to an execution condition being met or the path switch procedure. UE 501A may start a mobility timer (e.g., T304 as specified in 3GPP specifications) in response to the path switch procedure. For example, UE 501A may perform the path switch procedure according to one of the exemplary path switch procedures 520-550 (denoted by dotted line as an option). The exemplary path switch procedure 550 is further described with respect to FIG. 6.

In the case that target node 501B is a relay node, UE 501A may perform the path switch procedure according to path switch procedure 520.

According to path switch procedure 520, in operation 521, in response to discovering target node 501B, UE 501A may transmit an RRC reconfiguration sidelink message to target node 501B to establish a PC5 link with target node 501B. UE 501A may start a sidelink reconfiguration timer (e.g., T400 as specified in 3GPP specifications) in response to the transmission of the RRC reconfiguration sidelink message.

In the case that UE 501A has not discovered target node 501B, a UE discovery procedure may be performed between UE 501A and target node 501B before the transmission of the RRC reconfiguration sidelink message. For example, UE 501A may transmit a discovery message to target node 501B. The discovery message may indicate the ID of target node 501B configured by serving cell 502. Target node 501B may transmit a response message to UE 501A.

In operation 523, target node 501B may transmit an RRC reconfiguration complete sidelink message to UE 501A.

In operation 525, UE 501A may consider that the path switch is successful in response to the reception of the RRC reconfiguration complete sidelink message. UE 501A may stop at least one of the sidelink reconfiguration timer and the mobility timer in response to the RRC reconfiguration complete sidelink message.

In some embodiments of the present disclosure, when target node 501B is a relay served by serving cell 502, UE 501A may keep the at least one conditional path switch configuration configured by serving cell 502. When target node 501B is a relay served by a cell different from serving cell 502 (e.g., a neighbor cell of serving cell 502), UE 501A may release the at least one conditional path switch configuration configured by serving cell 502.

In operation 527, UE 501A may transmit an RRC reconfiguration complete message to serving cell 502 via target node 501B. The RRC reconfiguration complete message may be transmitted based on the configuration provided in the RRC reconfiguration message from serving cell 502 (e.g., in operation 513 shown in FIG. 5).

In the case that target node 501B is a cell, UE 501A may perform the path switch procedure according to path switch procedure 530. In this case, the path switch procedure may be also referred to as a CHO procedure.

According to path switch procedure 530, in operation 531, UE 501A may perform a random access (RA) with target node 501B. For example, UE 501A and target node 501B may perform an RA procedure (RAP) according to one of the known RAPs in the art.

In operation 533, in response to a successful RA or accessing target node 501B, UE 501A may stop at least one of the sidelink reconfiguration timer and the mobility timer.

In some embodiments of the present disclosure, when target node 501B is serving cell 502 (for example, UE 501A may switch from a relay link to a Uu link), UE 501A may keep the at least one conditional path switch configuration configured by serving cell 502. When target node 501B is a cell different from serving cell 502 (e.g., a neighbor cell of serving cell 502), UE 501A may release the at least one conditional path switch configuration configured by serving cell 502.

In operation 535, in response to a successful RA or accessing target node 501B, UE 501A may transmit an RRC reconfiguration complete message to serving cell 502.

In some cases, the path switch to a relay link may fail.

For example, according to path switch procedure 540, in operation 541, in response to discovering target node 501B, UE 501A may transmit an RRC reconfiguration sidelink message to target node 501B to establish a PC5 link with target node 501B. UE 501A may start a sidelink reconfiguration timer (e.g., T400 as specified in 3GPP specifications) in response to the transmission of the RRC reconfiguration sidelink message. In the case that UE 501A has not discovered target node 501B, a UE discovery procedure may be performed between UE 501A and target node 501B before the transmission of the RRC reconfiguration sidelink message.

In some embodiments of the present disclosure, UE 501A may receive an RRC reconfiguration failure sidelink message from target node 501B in operation 543 (denoted by dotted line as an option). In operation 545, UE 501A may stop the mobility timer and the sidelink reconfiguration timer in response to the reception of the RRC reconfiguration failure sidelink message. In some embodiments of the present disclosure, the sidelink reconfiguration timer may expire before receiving any message from target node 501B. In some examples, UE 501A may stop the mobility timer in response to the expiry of the sidelink reconfiguration timer. In some embodiments of the present disclosure, UE 501A may not stop the mobility timer in response to the reception of the RRC reconfiguration failure sidelink message or the expiry of the sidelink reconfiguration timer.

In operation 547, in response to the reception of the RRC reconfiguration failure sidelink message, or the expiry of the sidelink reconfiguration timer, or the expiry of the mobility timer, UE 501A may initiate a reestablishment procedure, for example, over the Uu interface (in the case that the source Uu link is detached). For example, UE 501A may select a suitable cell or a candidate relay and may access the selected cell or relay based on the reestablishment procedure.

In some embodiments of the present disclosure, UE 501A may fall back to the source Uu link in the case that the source Uu link between UE 501A and serving cell 502 is not detached. In some embodiments of the present disclosure, UE 501A may fall back to the source relay link in the case that the source relay link between UE 501A and its source serving relay (which is served by serving cell 502 and not shown in FIG. 5) is not detached.

In some embodiments of the present disclosure, a consecutive path switch may be configured. In some examples, the RRC reconfiguration message transmitted to UE 501A in operation 513 may include an indication of whether the consecutive path switch is allowed (or supported) or not. In the case that a consecutive path switch is allowed, the RRC reconfiguration message may further indicate a maximum number of path switches or a value of a timer for consecutive path switch.

In some examples, the RRC reconfiguration message may not include the above indication. UE 501A may implicitly determine whether the consecutive path switch is allowed or not. For instance, when a maximum number of path switches or a value of a timer for consecutive path switch is indicated in the RRC reconfiguration message, the UE may determine that the consecutive path switch is allowed. Otherwise, when neither a maximum number of path switches nor a value of a timer for consecutive path switch is indicated in the RRC reconfiguration message, the UE may determine that the consecutive path switch is not allowed.

When the maximum number of path switches is configured, UE 501A may initiate a counter for path switch in response to receiving the RRC reconfiguration message. For example, UE 501A may set the counter for path switch to zero in response to receiving the RRC reconfiguration message. Each time when UE 501A initiates or performs a path switch procedure with a corresponding target node, UE 501A may increment the counter for path switch by a value (e.g., 1).

When the value of the timer for consecutive path switch is configured, UE 501A may start the timer for consecutive path switch in response to the initiation or performance of the path switch procedure with the first target node (e.g., target node 501B in FIG. 6).

When the consecutive path switch is allowed, it is possible that UE 501A may need to perform more than one path switch procedures before successfully accessing a final target node. The mobility timer started in response to the initiation of each path switch procedure may only be associated with the target node (either a relay or a cell) in the corresponding path switch procedure.

When the consecutive path switch is allowed, UE 501A may perform the path switch procedure according to path switch procedure 550 as described in detail with respect to FIG. 6.

In FIG. 6, it is assumed that target node 501B and target node 501C are relay nodes. It should be appreciated by persons skilled in the art that either or both of target node 501B and target node 501C can be a cell.

Referring to FIG. 6, in operation 611, in response to discovering target node 501B, UE 501A may transmit an RRC reconfiguration sidelink message to target node 501B to establish a PC5 link with target node 501B. UE 501A may start a sidelink reconfiguration timer (e.g., T400 as specified in 3GPP specifications) in response to the transmission of the RRC reconfiguration sidelink message. In the case that UE 501A has not discovered target node 501B, a UE discovery procedure may be performed between UE 501A and target node 501B before the transmission of the RRC reconfiguration sidelink message.

UE 501A may increment the counter for path switch by a value (e.g., 1) in response to the transmission of the RRC reconfiguration sidelink message. Since it is the first time UE 501A tried to access a target node, the value of the counter for path switch may be set as 1 (i.e., increased from the initial value 0 to 1). UE 501A may start the timer for consecutive path switch in response to the transmission of the RRC reconfiguration sidelink message.

In some embodiments of the present disclosure, UE 501A may receive an RRC reconfiguration failure sidelink message from target node 501B in operation 613 (denoted by dotted line as an option). In operation 615, UE 501A may stop the mobility timer and the sidelink reconfiguration timer in response to the reception of the RRC reconfiguration failure sidelink message. In some embodiments of the present disclosure, the sidelink reconfiguration timer may expire before receiving any message from target node 501B. In some examples, UE 501A may stop the mobility timer in response to the expiry of the sidelink reconfiguration timer. In some embodiments of the present disclosure, UE 501A may not stop the mobility timer in response to the reception of the RRC reconfiguration failure sidelink message or the expiry of the sidelink reconfiguration timer.

In operation 615, in response to the reception of the RRC reconfiguration failure sidelink message, or the expiry of the sidelink reconfiguration timer, or the expiry of the mobility timer, UE 501A may select another candidate node, the execution for which is met, as the new target node. For example, UE 501A may determine to perform another path switch procedure with target node 501C.

In operation 617, UE 501A may transmit an RRC reconfiguration sidelink message to target node 501C. UE 501A may increment the counter for path switch by a value (e.g., 1) in response to the transmission of the RRC reconfiguration sidelink message. Since it is the second time UE 501A tried to access a target node, the value of the counter for path switch may be set as 2 (i.e., increased from 1 to 2).

In some embodiments of the present disclosure, in operation 619 (denoted by dotted line as an option), UE 501A may receive an RRC reconfiguration complete sidelink message from target node 501C. In some embodiments of the present disclosure, in response to the RRC reconfiguration complete sidelink message, UE 501A may stop the timer for consecutive path switch, the sidelink reconfiguration timer and the mobility timer, if configured. In operation 621 (denoted by dotted line as an option), UE 501A may transmit an RRC reconfiguration complete message to serving cell 502 via target node 501C.

In some embodiments of the present disclosure, in operation 623 (denoted by dotted line as an option), in response to the value of the counter for path switch being equal to or greater than the maximum number of path switches or the expiry of the timer for consecutive path switch, UE 501A may initiate a reestablishment procedure or fall back to the source Uu link.

It should be appreciated by persons skilled in the art that the sequence of the operations in exemplary procedures 500-550 may be changed and some of the operations in exemplary procedures 500-550 may be eliminated or modified, without departing from the spirit and scope of the disclosure.

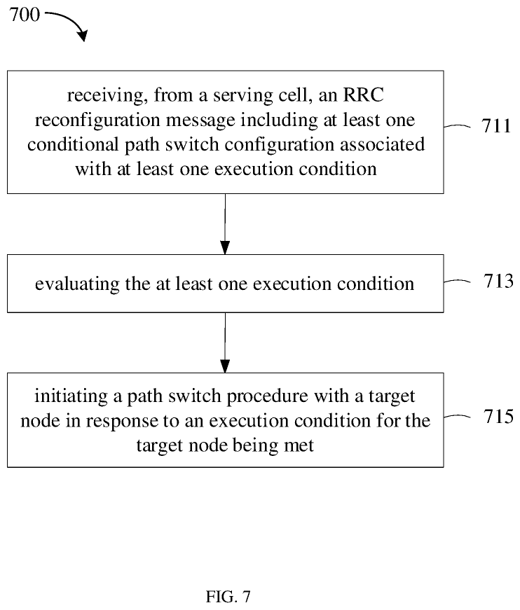

FIG. 7 illustrates an exemplary path switch procedure 700 in accordance with some embodiments of the present disclosure. Details described in all of the foregoing embodiments of the present disclosure are applicable for the embodiments shown in FIG. 7. In some examples, the procedure may be performed by a UE, for example, UE 501A in FIGS. 5 and 6.

Referring to FIG. 7, a UE may is accessing a cell (e.g., serving cell). In some examples, the UE may access the serving cell via a relay UE. In some examples, the UE may access the serving cell using a Uu interface.

In operation 711, the UE may receive an RRC reconfiguration message from the serving cell. The RRC reconfiguration message may include at least one conditional path switch configuration associated with at least one execution condition. Descriptions of the execution condition as described above with respect to FIG. 5 may apply here.

In some embodiments of the present disclosure, the at least one conditional path switch configuration may indicate one of: at least one execution condition for at least one candidate relay; at least one execution condition for at least one candidate cell; and at least one execution condition for at least one candidate relay and at least one execution condition for at least one candidate cell.

In some embodiments of the present disclosure, the at least one conditional path switch configuration may include a first conditional path switch configuration for one candidate relay or a list of candidate relays.

In some embodiments of the present disclosure, the at least one execution condition includes a first execution condition for one candidate relay or a list of candidate relays.

In some embodiments of the present disclosure, the RRC reconfiguration message may indicate: a first offset for a first channel quality based on a discovery message between the UE and a candidate relay when comparing the first channel quality with a second channel quality of a PC5 link associated with the UE; a second offset for the first channel quality when comparing the first channel quality with a third channel quality of a Uu link associated with the UE; and a third offset for the second channel quality when comparing the second channel quality with the third channel quality.

In some embodiments of the present disclosure, the UE may determine the channel quality of a PC5 link associated with the UE based on a sidelink primary synchronization signal (S-PSS), a sidelink secondary synchronization signal (S-SSS), or a physical sidelink broadcast channel (PSBCH).

In operation 713, the UE may evaluate the at least one execution condition.

In some embodiments of the present disclosure, in response to an execution condition for a candidate relay and an execution condition for a candidate cell being met, the UE may perform one of the following: selecting the candidate cell in priority; selecting the candidate relay in priority; and selecting a target node from the candidate relay and the candidate cell according to a best channel quality among the channel quality between the candidate relay and the UE and the channel quality between the candidate cell and the UE.

In some embodiments of the present disclosure, to select the target node according to the best channel quality, the UE may add an offset to the channel quality between the candidate relay and the UE. The UE may compare the added channel quality with the channel quality between the candidate cell and the UE.

In some embodiments of the present disclosure, in response to the execution condition for a plurality of candidate relays being met, the UE may select one of the plurality of candidate relays according to a best channel quality among the channel qualities between the plurality of candidate relays and the UE.

In some embodiments of the present disclosure, the UE may stop evaluate the at least one execution condition for the at least one candidate relay when a latency requirement of an ongoing service at the UE is less than or equal to a threshold. In some embodiments of the present disclosure, when a latency requirement of an ongoing service at the UE is less than or equal to a threshold, the UE may not select a candidate relay in response to an execution condition for the candidate relay being met. In some embodiments of the present disclosure, the at least one execution condition for the at least one candidate relay may include an execution condition that a latency between the UE and a candidate relay is less than or equal to a threshold. The latency between the UE and a candidate relay is determined based on a weighting factor.

In some embodiments of the present disclosure, the UE may determine that a plurality of candidate nodes satisfies a path switch condition in response to the execution condition for a plurality of candidate relays being met, the execution condition for a plurality of candidate cells being met, or the execution condition for one or more candidate relays and the execution condition for one or more candidate cells being met. The UE may select the target node from the plurality of candidate nodes based on latencies between the plurality of candidate nodes and the UE.

In some embodiments of the present disclosure, in response to the target node being the serving cell or a relay served by the serving cell, the UE may keep the at least one conditional path switch configuration. In response to the target node being a cell different from the serving cell or a relay served by the cell different from the serving cell, the UE may release the at least one conditional path switch configuration.

In operation 715, the UE may initiate a path switch procedure with a target node in response to an execution condition for the target node being met.

In some embodiments of the present disclosure, the RRC reconfiguration message may indicate at least one of: an indication of whether a consecutive path switch is allowed or not; a maximum number of path switches; and a value of a timer for consecutive path switch.

In some embodiments of the present disclosure, the UE may set a counter for path switch to zero in response to receiving the RRC reconfiguration message when the maximum number of path switches is indicated in the RRC reconfiguration message. The UE may increment the counter for path switch by a value in response to the initiation of the path switch procedure with the target node. In response to a failure to connect to the target node, the UE may initiate another path switch procedure with another target node. The UE may increment the counter for path switch by the value in response to the initiation of the another path switch procedure with the another target node.

In some embodiments of the present disclosure, the UE may start the timer for consecutive path switch in response to the initiation of the path switch procedure when the value of the timer for consecutive path switch is indicated in the RRC reconfiguration message.

In some embodiments of the present disclosure, in response to the value of the counter for path switch being equal to or greater than the maximum number of path switches or the expiry of the timer for consecutive path switch, the UE may initiate a reestablishment procedure or falling back to a Uu link between the UE and the serving cell.

It should be appreciated by persons skilled in the art that the sequence of the operations in exemplary procedure 700 may be changed and some of the operations in exemplary procedure 700 may be eliminated or modified, without departing from the spirit and scope of the disclosure.

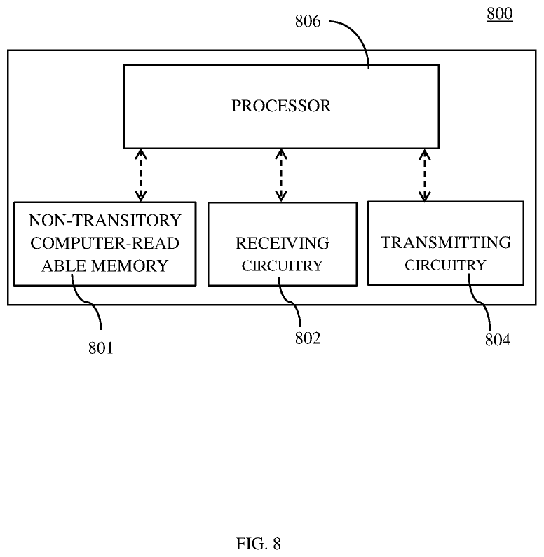

FIG. 8 illustrates a block diagram of an exemplary apparatus 800 according to some embodiments of the present disclosure.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The apparatus 800 may be a base station side apparatus (e.g., a BS) or a communication device (e.g., a UE).

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 are combined into a single device, such as a transceiver. In certain embodiments of the present application, the apparatus 800 may further include an input device, a memory, and/or other components.

In some embodiments of the present disclosure, the non-transitory computer-readable medium 801 may have stored thereon computer-executable instructions to cause a processor to implement the method with respect to the UEs as described above. For example, the computer-executable instructions, when executed, cause the processor 806 interacting with receiving circuitry 802 and transmitting circuitry 804, so as to perform the operations with respect to the UEs described in FIGS. 1-7.

In some embodiments of the present disclosure, the non-transitory computer-readable medium 801 may have stored thereon computer-executable instructions to cause a processor to implement the method with respect to the BSs as described above. For example, the computer-executable instructions, when executed, cause the processor 806 interacting with receiving circuitry 802 and transmitting circuitry 804, so as to perform the operations with respect to the BSs or cells described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

What is claimed is:

1. An apparatus, comprising:
a memory; and
a processor coupled to the memory, the processor configured to cause the apparatus to:
receive, at a user equipment (UE) from a serving cell, a radio resource control (RRC) reconfiguration message including at least one conditional path switch configuration associated with at least one execution condition;
evaluate the at least one execution condition; and
initiate a path switch procedure with a target node in response to an execution condition for the target node being met.

2. The apparatus of claim 1, wherein the at least one conditional path switch configuration indicates at least one one of:
at least one execution condition for at least one candidate relay;
at least one execution condition for at least one candidate cell; or
at least one execution condition for at least one candidate relay and at least one execution condition for at least one candidate cell.

3. The apparatus of claim 1, wherein the at least one conditional path switch configuration includes at least one of a first conditional path switch configuration for one candidate relay or a list of candidate relays.

4. The apparatus of claim 1, wherein the at least one execution condition includes at least one of a first execution condition for one candidate relay or a list of candidate relays.

5. The apparatus of claim 4, wherein the RRC reconfiguration message indicates:
a first offset for a first channel quality based on a discovery message between the UE and a candidate relay when comparing the first channel quality with a second channel quality of a PC5 link associated with the UE;
a second offset for the first channel quality when comparing the first channel quality with a third channel quality of a Uu link associated with the UE; and
a third offset for the second channel quality when comparing the second channel quality with the third channel quality.

6. The apparatus of claim 4, wherein the processor is configured to cause the apparatus to, in response to an execution condition for a candidate relay and an execution condition for a candidate cell being met, at least one of:
select the candidate cell in priority;
select the candidate relay in priority; or
select the target node from the candidate relay and the candidate cell according to a best channel quality among the channel quality between the candidate relay and the UE and the channel quality between the candidate cell and the UE.

7. The apparatus of claim 4, wherein the processor is configured to cause the apparatus to:
determine that a plurality of candidate nodes satisfies a path switch condition in response to at least one of the execution condition for a plurality of candidate relays being met, the execution condition for a plurality of candidate cells being met, or the execution condition for one or more candidate relays and the execution condition for one or more candidate cells being met; and
select the target node from the plurality of candidate nodes based on latencies between the plurality of candidate nodes and the UE.

8. The apparatus of claim 1, wherein the processor is configured to cause the apparatus to:
keep, in response to the target node being the serving cell or a relay served by the serving cell, the at least one conditional path switch configuration; and
release, in response to at least one of the target node being a cell different from the serving cell or a relay served by the cell different from the serving cell, the at least one conditional path switch configuration.

9. The apparatus of claim 1, wherein the RRC reconfiguration message indicates at least one of:
an indication of whether a consecutive path switch is allowed or not;
a maximum number of path switches; or
a value of a timer for consecutive path switch.

10. The apparatus of claim 9, wherein the processor is configured to cause the apparatus to:
set a counter for path switch to zero in response to receiving the RRC reconfiguration message when the maximum number of path switches is indicated in the RRC reconfiguration message.

11. The apparatus of claim 10, wherein the processor is configured to cause the apparatus to:
increment the counter for path switch by a value in response to the initiation of the path switch procedure with the target node.

12. The apparatus of claim 11, wherein the processor is configured to cause the apparatus to:
initiate, in response to a failure to connect to the target node, another path switch procedure with another target node; and
increment the counter for path switch by the value in response to the initiation of the another path switch procedure with the another target node.

13. The apparatus of claim 9, wherein the processor is configured to cause the apparatus to:
start the timer for consecutive path switch in response to the initiation of the path switch procedure when the value of the timer for consecutive path switch is indicated in the RRC reconfiguration message.

14. The apparatus of claim 9, wherein the processor is configured to cause the apparatus to:
initiate, in response to the value of a counter for path switch being equal to or greater than the maximum number of path switches or expiry of the timer for consecutive path switch, one or more of a reestablishment procedure or falling back to a Uu link between the UE and the serving cell.

15. (canceled)

16. A method, comprising:
receiving, at a user equipment (UE) from a serving cell, a radio resource control (RRC) reconfiguration message including at least one conditional path switch configuration associated with at least one execution condition;
evaluating the at least one execution condition; and
initiating a path switch procedure with a target node in response to an execution condition for the target node being met.

17. The method of claim 16, wherein the at least one conditional path switch configuration indicates one of:
at least one execution condition for at least one candidate relay;
at least one execution condition for at least one candidate cell; or
at least one execution condition for at least one candidate relay and at least one execution condition for at least one candidate cell.

18. The method of claim 16, wherein the at least one conditional path switch configuration includes at least one of a first conditional path switch configuration for one candidate relay or a list of candidate relays.

19. The method of claim 16, wherein the at least one execution condition includes a first execution condition for one candidate relay or a list of candidate relays.

20. The method of claim 19, wherein the RRC reconfiguration message indicates:
a first offset for a first channel quality based on a discovery message between the UE and a candidate relay when comparing the first channel quality with a second channel quality of a PC5 link associated with the UE;
a second offset for the first channel quality when comparing the first channel quality with a third channel quality of a Uu link associated with the UE; and
a third offset for the second channel quality when comparing the second channel quality with the third channel quality.

21. An apparatus comprising:
a memory; and
a processor coupled to the memory, the processor configured to cause the apparatus to:
receive, at a serving cell and from a first user equipment (UE), a measurement result associated with a second UE, the second UE comprising candidate relay UE; and
transmit, to the first UE, a radio resource control (RRC) reconfiguration message including at least one conditional path switch configuration associated with at least one execution condition.
